(19) United States
(12) Patent Application Publication
(10) Pub. No.: US 2017/0343782 A1
(43) Pub. Date: Nov. 30, 2017

(54) IMAGING OPTICAL SYSTEM, PROJECTION-TYPE DISPLAY APPARATUS, AND IMAGING APPARATUS

(71) Applicant: FUJIFILM Corporation, Tokyo (JP)

(72) Inventor: Masaru AMANO, Saitama (JP)

(73) Assignee: FUJIFILM Corporation, Tokyo (JP)

(21) Appl. No.: 15/602,811

(22) Filed: May 23, 2017

(30) Foreign Application Priority Data
May 25, 2016 (JP) 2016-104121

(51) Int. Cl. G02B 17/08; G02B 13/04; G02B 13/16; G03B 21/14

(52) U.S. Cl. CPC G02B 17/0896; G03B 21/14; G02B 13/04; G02B 13/16

(57) ABSTRACT

The imaging optical system consists of, in order from a magnified side, a first optical system consisting of a first lens group, first optical path bending means, and a second lens group, second optical path bending means, and a second optical system. The first optical path bending means and/or the second optical path bending means is disposed in a direction in which an optical path is bent by 90 degrees, the first optical system is capable of being rotated using an optical axis of the second lens group as an axis of rotation, and the following predetermined Conditional Expression (1) is satisfied.

|tan(θ)|<0.15 (1)

### CROSS REFERENCE TO RELATED APPLICATIONS

The present application claims priority under 35 U.S.C. §119 to Japanese Patent Application No. 2016-104121 filed on May 25, 2016. The above application is hereby expressly incorporated by reference, in its entirety, into the present application.

### BACKGROUND OF THE INVENTION

### 1. Field of the Invention

The present invention relates to an imaging optical system suitable for being used in a projection-type display apparatus having a light valve such as, particularly, a liquid crystal display device or a Digital Micromirror Device (DMD: Registered Trademark) mounted therein, a projection-type display apparatus including this imaging optical system, and an imaging apparatus including this imaging optical system.

### 2. Description of the Related Art

In recent years, projection-type display apparatuses (also called projectors), such as a liquid crystal display device or a DMD, having a light valve mounted therein have been in widespread use and have increased in performance.

In addition, with the recent improvement in the performance of a light valve, an imaging optical system which is combined with the light valve has required satisfactory aberration correction appropriate for the resolution of the light valve. Further, in consideration of use in a relatively narrow indoor space for the purpose of presentation or the like, an imaging optical system having a wider angle is strongly demanded.

In order to respond to such a demand, an imaging optical system is proposed in which an intermediate image is formed in a reduced-side optical system consisting of a plurality of lenses, and the image is re-formed likewise in a magnified-side optical system consisting of a plurality of lenses (see JP2006-330410A and JP2015-152764A).

In an imaging optical system constituted by only an optical system having no normal intermediate image formed thereon, in a case where an attempt is made to widen an angle by reducing a focal length, lenses on the magnified side become excessively large in any way. However, in the imaging optical system of an intermediate imaging type as described above, it is possible to shorten the back focus of the magnified-side optical system, and to reduce the magnified-side lens diameters of the magnified-side optical system. Therefore, the system is also suitable for widening an angle by reducing a focal length.

### SUMMARY OF THE INVENTION

Incidentally, applications of a projection-type display apparatus are diversified, and there are needs for vertical projection in which a projection direction of related art is inclined by 90 degrees, particularly, in a bulletin board application or the like. In order to cope therewith, a measure is taken to perform projection or the like in which the projection-type display apparatus is rotated by 90 degrees. However, since a light source used in the projection-type display apparatus generally uses a discharge lamp, its discharge electrode axis is directed in parallel to the direction of gravitational force, and thus there is a problem in that the lifetime of a light source is influenced or the like. Therefore, it does not mean that the projection-type display apparatus may be simply rotated by 90 degrees.

The present invention is contrived in view of such circumstances, and an object thereof is to provide an imaging optical system capable of readily switching horizontal or vertical projection without inclining a projection-type display apparatus by 90 degrees in a case of being mounted in the projection-type display apparatus, a projection-type display apparatus including this imaging optical system, and an imaging apparatus including this imaging optical system.

According to the present invention, there is provided an imaging optical system capable of projecting an image, displayed on an image display device disposed on a reduced-side conjugate plane, as a magnified image on a magnified-side conjugate plane, the system comprising, in order from a magnified side: a first optical system consisting of a first lens group, first optical path bending means for bending an optical path on a reflecting surface, and a second lens group; second optical path bending means for bending an optical path on a reflecting surface; and a second optical system which is constituted by a plurality of lenses, wherein the second optical system forms the image on the image display device as an intermediate image, the first optical system forms the intermediate image on the magnified-side conjugate plane, the first optical path bending means and/or the second optical path bending means is disposed in a direction in which the optical path is bent by 90 degrees, the first optical system is capable of being rotated using an optical axis of the second lens group as an axis of rotation, and the following Conditional Expression (1) is satisfied,

|tan(θ)|<0.15 (1)

where θ is a maximum angle among angles which are formed by respective principal rays of light from the second optical system toward the second optical path bending means with respect to the normal line of the reduced-side conjugate plane.

In the imaging optical system of the present invention, it is preferable to satisfy the following Conditional Expression (1-1).

|tan(θ)|<0.10 (1-1)

In addition, it is preferable to satisfy the following Conditional Expression (2), and more preferable to satisfy the following Conditional Expression (2-1),

0.02<|Imφ/exP|+|tan(θ)|<0.20 (2)

0.04<|Imφ/exP|+|tan(θ)|<0.18 (2-1)

where Imφ is an effective image circle diameter on the reduced side, and

exP is a distance on the optical axis from the reduced-side conjugate plane to a paraxial exit pupil position when the reduced side is set to an exit side.

In addition, it is preferable to satisfy the following Conditional Expression (3), and more preferable to satisfy the following Conditional Expression (3-1),

8.0<D12/|f|<30.0 (3)

10.0<D12/|f|<25.0 (3-1)

where D12 is a distance on the optical axis between the first optical system and the second optical system, and

f is a focal length of the whole system.

In addition, it is preferable to satisfy the following Conditional Expression (4), and more preferable to satisfy the following Conditional Expression (4-1),

1.2<f1/|f|<2.8 (4)

1.4<f1/|f|<2.2 (4-1)

where f1 is a focal length of the first optical system, and

f is a focal length of the whole system.

In addition, it is preferable to satisfy the following Conditional Expression (5), and more preferable to satisfy the following Conditional Expression (5-1),

4.0<Bf/|f| (5)

5.0<Bf/|f|<20.0 (5-1)

where Bf is a back focus of the whole system, and

f is a focal length of the whole system.

In addition, in the first and second imaging optical systems of the present invention, it is preferable that the first optical system and the second optical system have a common optical axis.

In addition, in the first and second imaging optical systems of the present invention, it is preferable that the intermediate image has an image plane curvature on the second optical system side in its peripheral portion rather than a center of an optical axis.

According to the present invention, there is provided a projection-type display apparatus comprising: a light source; a light valve on which light from the light source is incident; and the imaging optical system of the present invention as an imaging optical system that projects an optical image of light optically modulated by the light valve onto a screen.

According to the present invention, there is provided an imaging apparatus comprising the imaging optical system of the present invention.

Meanwhile, the term “magnified side” means a projected side (screen side), and the screen side is assumed to be referred to as the magnified side, for the sake of convenience, even in a case of reduction projection. On the other hand, the term “reduced side” means an image display device side (light valve side), and the light valve side is assumed to be referred to as the reduced side, for the sake of convenience, even in a case of reduction projection.

In addition, the term “consist of” is intended to be allowed to include lenses having substantially no power, optical elements, such as a mirror, a diaphragm, a mask, cover glass, or a filter having no power, other than a lens, and the like, in addition to the things enumerated as components.

In addition, the term “lens group” is not necessarily constituted by a plurality of lenses, but may be constituted by only one lens.

In addition, regarding the “back focus”, it is considered that the magnified side and the reduced side are equivalent to an object side and an image side of a general imaging lens, respectively, and the magnified side and the reduced side are set to a front side and a back side, respectively.

In addition, the surface shape of the lens and the sign of the refractive power thereof are assumed to be those in a paraxial region in a case where an aspherical surface is included.

In addition, in the calculation of the conditional expressions, the “focal length f of the whole system” is set to a value when a projection distance is set to be infinite.

According to the present invention, there is provided an imaging optical system capable of projecting an image, displayed on an image display device disposed on a reduced-side conjugate plane, as a magnified image on a magnified-side conjugate plane, the system comprising, in order from a magnified side: a first optical system consisting of a first lens group, first optical path bending means for bending an optical path on a reflecting surface, and a second lens group; second optical path bending means for bending an optical path on a reflecting surface; and a second optical system which is constituted by a plurality of lenses, wherein the second optical system forms the image on the image display device as an intermediate image, the first optical system forms the intermediate image on the magnified-side conjugate plane, the first optical path bending means and/or the second optical path bending means is disposed in a direction in which the optical path is bent by 90 degrees, the first optical system is capable of being rotated using an optical axis of the second lens group as an axis of rotation, and the following Conditional Expression (1) is satisfied. Therefore, it is possible to form an imaging optical system capable of readily switching horizontal or vertical projection without inclining a projection-type display apparatus by 90 degrees in a case of being mounted in the projection-type display apparatus.

|tan(θ)|<0.15 (1)

Since the projection-type display apparatus of the present invention includes the imaging optical system of the present invention, it is possible to readily switch horizontal or vertical projection without inclining the projection-type display apparatus by 90 degrees.

The imaging apparatus of the present invention includes the imaging optical system of the present invention, and thus it is possible to change the installation shape or optical axis direction of the imaging optical system within the imaging apparatus with a high degree of freedom. Therefore, it is possible to improve the design freedom of the imaging apparatus.

### BRIEF DESCRIPTION OF THE DRAWINGS

FIG. 1 is a cross-sectional view illustrating a configuration (in common with that of Example 1) of an imaging optical system according to an embodiment of the present invention.

FIG. 2 is a cross-sectional view illustrating a configuration of an imaging optical system of Example 2 of the present invention.

FIG. 3 is a cross-sectional view illustrating a configuration of an imaging optical system of Example 3 of the present invention.

FIG. 4 is a cross-sectional view illustrating a configuration of an imaging optical system of Example 4 of the present invention.

FIG. 5 is a diagram of aberrations of an imaging optical system of Example 1 of the present invention.

FIG. 6 is a diagram of aberrations of an imaging optical system of Example 2 of the present invention.

FIG. 7 is a diagram of aberrations of an imaging optical system of Example 3 of the present invention.

FIG. 8 is a diagram of aberrations of an imaging optical system of Example 4 of the present invention.

FIG. 9 is a schematic configuration diagram of a projection-type display apparatus according to an embodiment of the present invention.

FIG. 10 is a schematic configuration diagram of a projection-type display apparatus according to another embodiment of the present invention.

FIG. 11 is a schematic configuration diagram of a projection-type display apparatus according to still another embodiment of the present invention.

FIG. 12 is a perspective view of a front side of an imaging apparatus according to an embodiment of the present invention.

FIG. 13 is a perspective view of a rear surface side of the imaging apparatus shown in FIG. 12.

### DESCRIPTION OF THE PREFERRED EMBODIMENTS

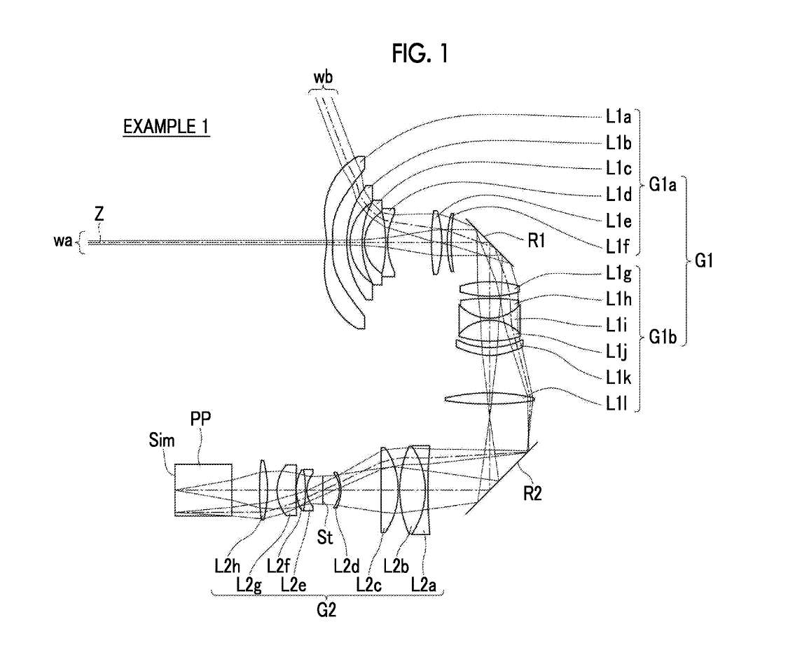

Hereinafter, embodiments of the present invention will be described in detail with reference to the accompanying drawings. FIG. 1 is a cross-sectional view illustrating a configuration of an imaging optical system according to an embodiment of the present invention. The configuration example shown in FIG. 1 is in common with a configuration of an imaging optical system of Example 1 described later. In FIG. 1, an image display surface Sim side is a reduced side, a lens L1a side of a first optical system G1 is a magnified side, and a shown aperture diaphragm St does not necessarily indicates a size or a shape, but indicates a position on an optical axis Z. In addition, in FIG. 1, an on-axis light flux wa and a light flux wb of the maximum angle of view are also shown together.

This imaging optical system is mounted on, for example, a projection-type display apparatus, and can be used in projecting image information displayed on a light valve onto a screen. In FIG. 1, on the assumption of a case of being mounted on the projection-type display apparatus, an optical member PP assumed to be a filter, a prism and the like which are used in a color synthesis portion or an illumination light separation portion, and the image display surface Sim of the light valve located on the surface of the optical member PP on the reduced side are also shown together. In the projection-type display apparatus, a light flux to which image information is given on the image display surface Sim on an image display device is incident on this imaging optical system through the optical member PP, and is projected onto a screen, not shown, by this imaging optical system.

As shown in FIG. 1, the imaging optical system of the present embodiment consists of a first optical system G1 consisting of a first lens group G1a, first optical path bending means R1 for bending an optical path on a reflecting surface, and a second lens group G1b, second optical path bending means R2 for bending an optical path on a reflecting surface, and a second optical system G2 constituted by a plurality of lenses, in order from the magnified side. The second optical system G2 is configured to form an image on the image display surface Sim as an intermediate image, and the first optical system G1 is configured to form the intermediate image on a magnified-side conjugate plane.

In an optical system for projection constituted by only an optical system having no normal intermediate image formed thereon, in a case where an attempt is made to widen an angle by reducing a focal length, a lens on the magnified side becomes excessively large in any way. However, in an optical system for projection of a type in which intermediate imaging is performed as in the present embodiment, it is possible to shorten a back focus of the first optical system G1, and to reduce lens diameters of the first optical system G1 on the magnified side. Therefore, the system is suitable for widening an angle by reducing a focal length.

In addition, the first optical path bending means R1 and/or the second optical path bending means R2 is configured to be disposed in a direction in which the optical path is bent by 90 degrees, and to be capable of rotating the first optical system G1 using the optical axis of the second lens group G1b as an axis of rotation.

With such a configuration, it is possible to switch between horizontal projection and vertical projection, without causing a problem such as an influence on the lifetime of a light source in the projection-type display apparatus, just through the contrivance of an imaging optical system. In addition, the optical path bending means R1 and R2 are disposed at the intermediate position of the imaging optical system, and thus it is possible to achieve a further reduction in the size of the optical path bending means than in a case where the optical path bending means is disposed on the magnified side of the imaging optical system. In addition, two optical path bending means are provided in the imaging optical system, and thus it is easy to reduce the size of the entire imaging optical system and to control a projection direction.

In addition, it is configured to satisfy the following Conditional Expression (1).

|tan(θ)|<0.15 (1)

|tan(θ)|<0.10 (1-1)

Here, θ is a maximum angle among angles which are formed by respective principal rays of light from the second optical system toward the second optical path bending means with respect to the normal line of a reduced-side conjugate plane.

In a case where at least a portion of the first optical system G1 is rotated as described above, it is considered that a change occurs in projection performance, during switching between horizontal projection and vertical projection, due to the influence of axial misalignment occurring by the axis of rotation and the optical axis of the second lens group G1b being misaligned, the influence of axial misalignment caused by backlash occurring during rotation, and/or the like. Conditional Expression (1) is an expression for satisfactorily correcting a projection performance change caused by this rotation. Here, θ is a maximum angle among angles which are formed by respective principal rays of light from the second optical system G2 toward the second optical path bending means R1 with respect to the normal line of the reduced-side conjugate plane (image display surface Sim). The value is not set to be equal to or greater than the upper limit of Conditional Expression (1), and thus it is possible to suppress a change in the performance (image split and/or one-sided blur caused by eccentricity) of the first optical system G1 with respect to axial misalignment. Meanwhile, in a case where the Conditional Expression (1-1) is satisfied, it is possible to make characteristics more satisfactory.

In this manner, the components of the imaging optical system are disposed as described above and Conditional Expression (1) is satisfied. Thereby, it is possible to switch between horizontal projection and vertical projection, without causing a problem such as an influence on the lifetime of a light source in the projection-type display apparatus, while having high optical performance.

In the imaging optical system of the present embodiment, it is preferable to satisfy the following Conditional Expression (2). Conditional Expression (2) is a conditional expression for securing telecentricity while obtaining the size of a desired effective image circle diameter, and is a conditional expression for not increasing the angle of incidence on the second optical path bending means R2 from the second optical system G2 while securing telecentricity on the reduced side, that is, for maintaining a state close to both-side telecentric in the second optical system G2. Conditional Expression (2) is satisfied, and thus it is possible to secure telecentricity on the reduced side, and to suppress the angle of incidence on the second optical path bending means R2 from the second optical system G2. Therefore, as a result, it is possible to suppress a change in the performance (image split and/or one-sided blur caused by eccentricity) of the first optical system G1 with respect to axial misalignment. Meanwhile, in a case where the following Conditional Expression (2-1) is satisfied, it is possible to make characteristics more satisfactory.

0.02<|Imφ/exP|+|tan(θ)|<0.20 (2)

0.04<|Imφ/exP|+|tan(θ)|<0.18 (2-1)

Here, Imφ is an effective image circle diameter on the reduced side, and

exP is a distance on the optical axis from the reduced-side conjugate plane to a paraxial exit pupil position when the reduced side is set to an exit side.

In addition, it is preferable to satisfy the following Conditional Expression (3). Conditional Expression (3) is an expression for specifying the ratio of the focal length of the whole system to a distance from the first optical system G1 to the second optical system G2. The ratio value is not set to be equal to or greater than the upper limit of Conditional Expression (3), and thus a distance between the first optical system G1 and the second optical system G2 is prevented from excessively increasing, which leads to contribution to a reduction in size. The ratio value is not set to be equal to or less than the lower limit of Conditional Expression (3), and thus it is possible to secure a space for the second optical path bending means R2, and to dispose the second optical path bending means R2 at a position deviating from the vicinity of the image formation plane of the intermediate image. Therefore, it is possible to reduce the possibility of dust, stain and/or the like on the second optical path bending means R2 being reflected on a screen. That is, Conditional Expression (3) is satisfied, and thus the distance from the first optical system G1 to the second optical system G2 is appropriately secured without increasing in size, which leads to the regulation of the angle of emergence of the principal ray of light incident on the second optical path bending means R2 from the second optical system G2, and to, as a result, the suppression of a change in the performance (image split and/or one-sided blur caused by eccentricity) of the first optical system G1 with respect to axial misalignment. Meanwhile, in a case where the following Conditional Expression (3-1) is satisfied, it is possible to make characteristics more satisfactory.

8.0<D12/|f|<30.0 (3)

10.0<D12/|f|<25.0 (3-1)

Here, D12 is a distance on the optical axis between the first optical system and the second optical system, and

f is a focal length of the whole system.

In addition, it is preferable to satisfy the following Conditional Expression (4). Conditional Expression (4) is an expression for specifying the ratio of the focal length of the whole system to the focal length of the first optical system, and this is equivalent to the relay magnification of the second optical system G2 that forms the intermediate image. The ratio value is not set to be equal to or greater than the upper limit of Conditional Expression (4), and thus it is possible to prevent the size of the intermediate image from excessively increasing by suppressing the relay magnification of the second optical system G2. Therefore, it is possible to prevent an increase in the size of the lens diameter of the first optical system G1, and to make it easy to correct distortion and/or image plane curvature in the first optical system G1. The ratio value is not set to be equal to or less than the lower limit of Conditional Expression (4), and thus it is possible to appropriately set a relay magnification required for achieving a wide angle using a relay system, and to thereby appropriately correct various aberrations which are problems in a wide angle while achieving the wide angle. Meanwhile, in a case where the following Conditional Expression (4-1) is satisfied, it is possible to make characteristics more satisfactory.

1.2<f1/|f|<2.8 (4)

1.4<f1/|f|<2.2 (4-1)

Here, f1 is a focal length of the first optical system, and

f is a focal length of the whole system.

In addition, it is preferable to satisfy the following Conditional Expression (5). Conditional Expression (5) is an expression for specifying the ratio of the focal length of the whole system to the back focus of the whole system. The ratio value is not set to be equal to or greater than the upper limit of Conditional Expression (5), and thus it is possible to prevent an increase in the size of the whole lens system inclusive of a back focus. The ratio value is not set to be equal to or less than the lower limit of Conditional Expression (5), and thus it is possible to prevent difficulty in disposing a color synthesis prism or the like due to an excessive reduction in the back focus. Meanwhile, in a case where the following Conditional Expression (5-1) is satisfied, it is possible to make characteristics more satisfactory.

4.0<Bf/|f| (5)

5.0<Bf/|f|<20.0 (5-1)

Here, Bf is a back focus of the whole system, and

f is a focal length of the whole system.

In addition, in the imaging optical systems of the first and second embodiments, it is preferable that the first optical system G1 and the second optical system G2 have a common optical axis. With such a configuration, the structure of the entire optical system can be simplified, and thus it is possible to contribute to a reduction in cost.

In addition, in the imaging optical systems of the first and second embodiments, it is preferable that the intermediate image has an image plane curvature on the second optical system G2 side in its peripheral portion rather than the center of an optical axis. In this manner, aberration correction is not performed independently in the first optical system G1 and the second optical system G2, but distortion aberration, astigmatism and the like are caused to remain in the second optical system G2, and aberration correction in which these aberrations are offset in the first optical system G1 is performed. Thereby, it is possible to improve various aberrations while achieving a wide angle even using a small number of lenses.

Next, numerical value examples of the imaging optical system of the present invention will be described.

First, an imaging optical system of Example 1 will be described. FIG. 1 shows a cross-sectional view illustrating a configuration of the imaging optical system of Example 1. Meanwhile, in FIG. 1 and FIGS. 2 to 4 corresponding to Examples 2 to 4 described later, an image display surface Sim side is a reduced side, a lens L1a side of a first optical system G1 is a magnified side, and a shown aperture diaphragm St does not necessarily indicates a size or a shape, but indicates a position on the optical axis Z. In addition, in FIGS. 1 to 4, an on-axis light flux wa and a light flux wb of the maximum angle of view are also shown together.

The imaging optical system of Example 1 is constituted by the first optical system G1 including the first optical path bending means R1, the second optical path bending means R2, and the second optical system G2, in order from the magnified side. The first optical system G1 is constituted by twelve lenses of lenses L1a to L1l, and the second optical system G2 is constituted by eight lenses of lenses L2a to L2h.

Table 1 shows lens data of the imaging optical system of Example 1, Table 2 shows data relating to surface spacings having a change in spacing during focusing, Table 3 shows data relating to specifications, and Table 4 shows data relating to aspherical coefficients. In the following, the meanings of symbols in the tables will be described by taking an example of those in Example 1, but the same is basically true of Examples 2 to 4.

In the lens data of Table 1, the column of a surface number indicates surface numbers sequentially increasing toward the reduced side with the surface of a component on the most magnified side set to a first surface, the column of a radius of curvature indicates radii of curvature of respective surfaces, and the column of a surface spacing indicates distances on the optical axis Z between the respective surfaces and the next surfaces. In addition, the column of n indicates refractive indexes of respective optical elements with respect to a d line (wavelength of 587.6 nm), and the column of ν indicates Abbe numbers of the respective optical elements with respect to the d line (wavelength of 587.6 nm). Here, the sign of the radius of curvature is set to be positive in a case where a surface shape is convex on the magnified side, and is set to be negative in a case where a surface shape is convex on the reduced side. The lens data also indicates the aperture diaphragm St and the optical member PP together. In the place of a surface number of a surface equivalent to the aperture diaphragm St, a term of (diaphragm) is written together with the surface number. In addition, in the lens data, DD [surface number] is written in the places of surface spacings having a change in spacing during focusing. Numerical values corresponding to DD [surface number] shown in Table 2.

The data relating to specifications of Table 3 indicates values a focal length f′, a back focus Bf′, an F-Number FNo, and the total angle of view 2ω when a projection distance is set to 193.406.

Meanwhile, numerical values shown in data relating to basic lens data and specifications are standardized so that the focal length of the whole system at the projection distances of the specifications is set to −1. In addition, the numerical values of each table are rounded off to predetermined decimal places.

In the lens data of Table 1, mark * is attached to the surface number of an aspherical surface, and the numerical values of a paraxial radius of curvature are indicated as the radius of curvature of the aspherical surface. The data relating to the aspherical coefficients of Table 4 indicates surface numbers of the aspherical surfaces and aspherical coefficients relating to these aspherical surfaces. “E-n” (n is an integer) in the numerical values of the aspherical coefficients of Table 4 means “×10⁻ⁿ”. The aspherical coefficients are values of respective coefficients KA and Am (m=3 to 20) in an aspherical expression represented by the following expression.

Zd=C·h²/{1+(1−KA·C²·h²)^{1/2}}+ΣAm·h^{m}

Here, Zd is an aspherical depth (length of a vertical line drawn from a point on an aspherical surface having a height h down to a plane perpendicular to the optical axis with which the vertex of the aspherical surface is in contact),

h is a height (distance from the optical axis),

C is a reciprocal of the paraxial radius of curvature, and

KA and Am are aspherical coefficients (m=3 to 20).

TABLE 1
Example 1: Lens data (n and ν are based on the d line)

| SURFACE | RADIUS OF | SURFACE | | |
|---|---|---|---|---|
| NUMBER | CURVATURE | SPACING | n | ν |
| *1 | −5.2258 | 0.7360 | 1.53158 | 55.08 |
| *2 | −14.4830 | 1.6688 | | |
| 3 | 10.9737 | 0.3937 | 1.83481 | 42.72 |
| 4 | 5.6865 | 1.4329 | | |
| 5 | 10.0545 | 0.2995 | 1.91082 | 35.25 |
| 6 | 4.2275 | 2.5121 | | |
| 7 | −15.2778 | 0.2311 | 1.72916 | 54.68 |
| 8 | 7.6744 | 5.2322 | | |
| 9 | 28.2991 | 1.2357 | 1.80610 | 33.27 |
| 10 | −13.1238 | DD[10] | | |
| 11 | 12.6584 | 0.4655 | 1.84666 | 23.78 |
| 12 | 19.8736 | DD[12] | | |
| 13 | 12.0143 | 1.7218 | 1.49700 | 81.61 |
| 14 | −12.0143 | 0.2516 | | |
| 15 | 24.8613 | 2.3517 | 1.67790 | 55.34 |
| 16 | −4.8915 | 0.2311 | 1.80518 | 25.46 |
| 17 | 4.8915 | 2.4852 | 1.49700 | 81.61 |
| 18 | −12.0513 | 0.7514 | | |
| *19 | −7.1510 | 0.9414 | 1.51007 | 56.24 |
| *20 | −5.3495 | 4.4056 | | |
| 21 | 22.9057 | 1.3282 | 1.84666 | 23.78 |
| 22 | −34.7748 | 17.5452 | | |
| 23 | −64.7115 | 0.3252 | 1.80610 | 33.27 |
| 24 | 9.2416 | 3.0414 | 1.63854 | 53.38 |
| 25 | −12.6122 | 0.1712 | | |
| 26 | 8.7758 | 2.0539 | 1.69680 | 55.53 |
| 27 | ∞ | 4.7924 | | |
| 28 | 4.6731 | 0.1729 | 1.59270 | 35.31 |
| 29 | 3.4032 | 1.9837 | | |
| 30 (DIAPHRAGM) | ∞ | 1.8913 | | |
| 31 | −3.0344 | 0.1712 | 1.80518 | 25.46 |
| 32 | 12.6113 | 1.1057 | 1.59282 | 68.62 |
| 33 | −4.8375 | 0.0342 | | |
| 34 | −57.4762 | 2.2421 | 1.49700 | 81.61 |
| 35 | −4.7173 | 1.1502 | | |
| 36 | 13.8428 | 0.9568 | 1.92286 | 20.88 |
| 37 | −27.2944 | 3.2889 | | |
| 38 | ∞ | 6.7786 | 1.51633 | 64.14 |
| 39 | ∞ | | | |

First optical path bending means: position of 4.6212 on magnified side from surface number 13

Second optical path bending means: position of 7.3597 on magnified side from surface number 23

TABLE 2
Example 1: Surface spacings

| PROJECTION | | | | |
|---|---|---|---|---|
| DISTANCE | 193.406 | 121.521 | 468.967 | ∞ |
| DD[10] | 0.6421 | 0.8789 | 0.3986 | 0.2225 |
| DD[12] | 9.2180 | 8.9812 | 9.4615 | 9.6376 |

TABLE 3
Example 1: Specifications (d line)

| | |
|---|---|
| f′ | −1.00 |
| Bf′ | 7.76 |
| FNo. | 1.91 |
| 2ω[°] | 138.0 |

TABLE 4
Example 1: Aspherical coefficients

| SURFACE | | | |
|---|---|---|---|
| NUMBER | 1 | 2 | 19 |
| KA | −1.546378300122E+00 | −6.938246778737E+01 | −4.260756389852E−01 |
| A3 | 2.018863389167E−02 | 3.135869415357E−02 | −5.094545177229E−03 |
| A4 | 3.047810683562E−03 | −2.989646897191E−02 | 1.311855979326E−02 |
| A5 | −1.669807535484E−03 | 3.677207805828E−02 | −5.611217310945E−03 |
| A6 | 1.154294171845E−04 | −2.990889576397E−02 | −1.633075426131E−03 |
| A7 | 3.249222906876E−05 | 1.666983136218E−02 | 2.434226410868E−03 |
| A8 | −4.253102539216E−06 | −6.627516042915E−03 | −3.423229558501E−04 |
| A9 | −4.424038232000E−07 | 1.914682928514E−03 | −4.527267198745E−04 |
| A10 | 8.245832143873E−08 | −4.053401733698E−04 | 1.544918621372E−04 |
| A11 | 4.288038152692E−09 | 6.288867705223E−05 | 3.707454554667E−05 |
| A12 | −1.009517143718E−09 | −7.077805600361E−06 | −2.337823471038E−05 |
| A13 | −3.928910017049E−11 | 5.629944648839E−07 | −2.029922108751E−07 |
| A14 | 9.188892344839E−12 | −2.997619234324E−08 | 1.728137683772E−06 |
| A15 | 2.854707126548E−13 | 9.489436391692E−10 | −1.756408094208E−07 |
| A16 | −6.073887356486E−14 | −1.286239784502E−11 | −5.970062664740E−08 |
| A17 | −1.058687065632E−15 | 1.516543284299E−14 | 1.113194098830E−08 |
| A18 | 2.357443732956E−16 | −4.670276371805E−15 | 5.447426702441E−10 |
| A19 | 1.116119782618E−18 | −3.190130207468E−17 | −2.180703780510E−10 |
| A20 | −3.658215332719E−19 | 1.042364006359E−17 | 1.042467028344E−11 |

| SURFACE | |
|---|---|
| NUMBER | 20 |
| KA | 5.923802980090E−01 |
| A3 | −4.049535376063E−03 |
| A4 | 1.205983297241E−02 |
| A5 | −3.710237995376E−03 |
| A6 | −6.446587800793E−04 |
| A7 | 9.705857875631E−04 |
| A8 | −1.036740768513E−04 |
| A9 | −1.481035527610E−04 |
| A10 | 3.796487747518E−05 |
| A11 | 1.139864470430E−05 |
| A12 | −5.114123231341E−06 |
| A13 | −1.533820057677E−07 |
| A14 | 3.274692501526E−07 |
| A15 | −3.329005538927E−08 |
| A16 | −8.904987889237E−09 |
| A17 | 1.988014493344E−09 |
| A18 | 1.706750172651E−11 |
| A19 | −3.433778947339E−11 |
| A20 | 2.361405547132E−12 |

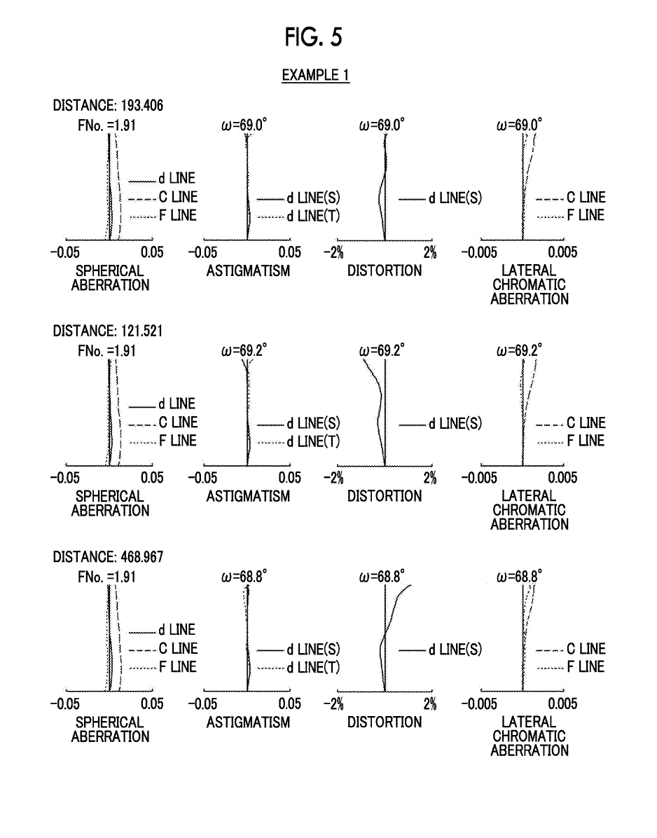

FIG. 5 shows a diagram of aberrations of the imaging optical system of Example 1. Meanwhile, FIG. 5 shows an aberration diagram at three projection distances, and shows spherical aberration, astigmatism, distortion aberration, and lateral chromatic aberration, in order from the left side in FIG. 5. The diagram of aberrations indicating spherical aberration, astigmatism, and distortion aberration indicates aberrations in which the d line (wavelength of 587.6 nm) is used as a reference wavelength. In the spherical aberration diagram, aberrations relating to the d line (wavelength of 587.6 nm), a C line (wavelength of 656.3 nm), and an F line (wavelength of 486.1 nm) are indicated by a solid line, a long dashed line, and a short dashed line, respectively. In the astigmatism diagram, aberrations in a sagittal direction and a tangential direction are indicated by a solid line and a short dashed line, respectively. In the lateral chromatic aberration diagram, aberrations relating to the C line (wavelength of 656.3 nm) and the F line (wavelength of 486.1 nm) are indicated by a long dashed line and a short dashed line, respectively. FNo. in the spherical aberration diagram means an F-Number, and ω in the other aberration diagrams means a half angle of view.

In the description of Example 1, symbols, meanings, and description methods of the respective pieces of data are the same as those in the following examples unless otherwise noted, and thus the repeated description thereof will be omitted below.

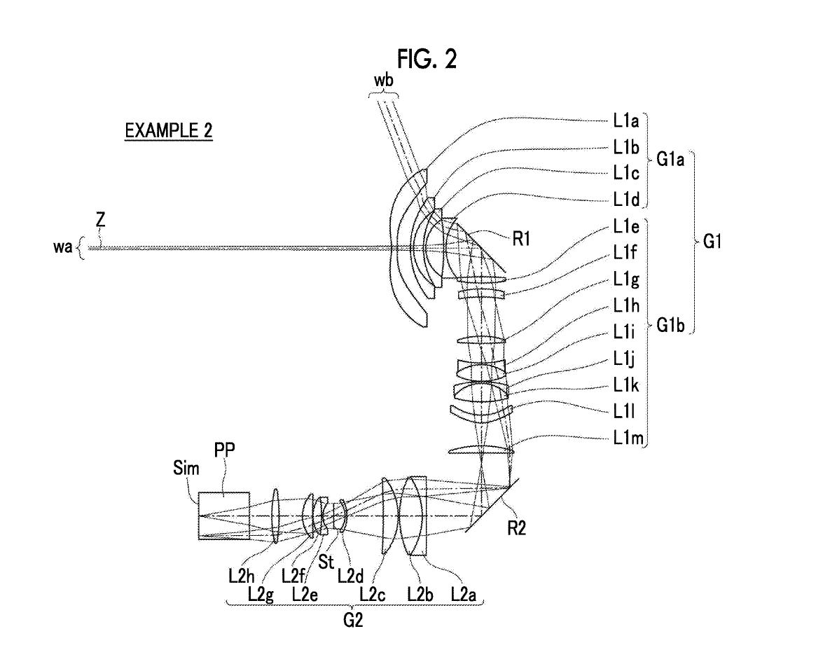

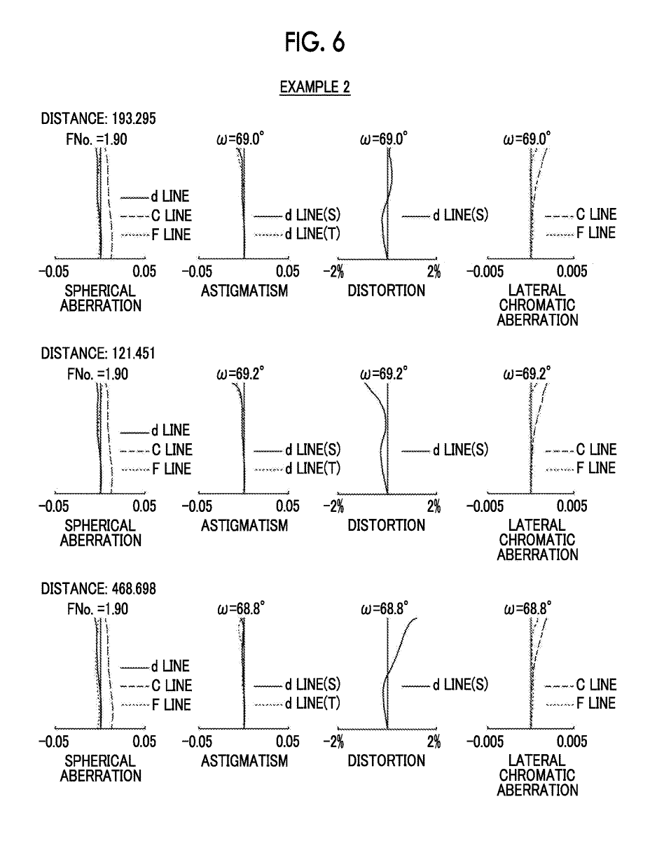

Next, an imaging optical system of Example 2 will be described. FIG. 2 shows a cross-sectional view illustrating a configuration of the imaging optical system of Example 2. The imaging optical system of Example 2 has the same lens number configuration as that in Example 1, except that a first optical system G1 is constituted by thirteen lenses of lenses L1a to L1m. In addition, Table 5 shows lens data of the imaging optical system of Example 2, Table 6 shows data relating to surface spacings having a change in spacing during focusing, Table 7 shows data (projection distance of 193.295) relating to specifications, Table 8 shows data relating to aspherical coefficients, and FIG. 6 shows a diagram of aberrations.

TABLE 5
Example 2: Lens data (n and ν are based on the d line)

| SURFACE | RADIUS OF | SURFACE | | |
|---|---|---|---|---|
| NUMBER | CURVATURE | SPACING | n | ν |
| *1 | −5.8964 | 0.7697 | 1.53158 | 55.08 |
| *2 | −19.0272 | 1.7458 | | |
| 3 | 10.5522 | 0.4275 | 1.83481 | 42.72 |
| 4 | 5.9178 | 1.3190 | | |
| 5 | 9.2704 | 0.3079 | 1.91082 | 35.25 |
| 6 | 4.4226 | 2.4107 | | |
| 7 | −27.0447 | 0.2736 | 1.72916 | 54.68 |
| 8 | 6.0293 | 8.5528 | | |
| 9 | 39.7995 | 0.8362 | 1.85478 | 24.80 |
| 10 | −18.8770 | DD[10] | | |
| 11 | 12.1277 | 1.0582 | 1.67270 | 32.10 |
| 12 | 17.7260 | DD[12] | | |
| 13 | 10.2472 | 0.9655 | 1.59282 | 68.62 |
| 14 | −33.5356 | 2.5904 | | |
| 15 | −12.5421 | 0.2222 | 1.84666 | 23.78 |
| 16 | 5.5094 | 2.2232 | 1.59282 | 68.62 |
| 17 | −7.4156 | 0.0343 | | |
| 18 | 12.7105 | 0.2310 | 1.80610 | 33.27 |
| 19 | 4.8440 | 2.4475 | 1.49700 | 81.61 |
| 20 | −13.1174 | 1.7674 | | |
| *21 | −5.2479 | 1.0265 | 1.49100 | 57.58 |
| *22 | −4.2922 | 3.0320 | | |
| 23 | 13.7187 | 0.9529 | 1.60311 | 60.64 |
| 24 | 248.4579 | 15.7258 | | |
| 25 | 887.4293 | 0.5473 | 1.80610 | 33.27 |
| 26 | 9.2682 | 3.0347 | 1.63854 | 55.38 |
| 27 | −12.1294 | 0.1709 | | |
| 28 | 8.0168 | 2.0069 | 1.69680 | 55.53 |
| 29 | 95.7147 | 4.8487 | | |
| 30 | 4.8446 | 0.2347 | 1.51823 | 58.90 |
| 31 | 2.9545 | 1.5201 | | |
| 32 (DIAPHRAGM) | ∞ | 1.4622 | | |
| 33 | −2.6701 | 0.1711 | 1.80518 | 25.46 |
| 34 | 15.8216 | 1.1524 | 1.59282 | 68.62 |
| 35 | −4.1529 | 0.0343 | | |
| 36 | −103.6182 | 1.3648 | 1.49700 | 81.61 |
| 37 | −4.3229 | 3.1657 | | |
| 38 | 21.2137 | 0.9847 | 1.89286 | 20.36 |
| 39 | −15.6497 | 2.9778 | | |
| 40 | ∞ | 6.7747 | 1.51633 | 64.14 |
| 41 | ∞ | | | |

First optical path bending means: position of 3.8000 on magnified side from surface number 9

Second optical path bending means: position of 7.3597 on magnified side from surface number 25

TABLE 6
Example 2: Surface spacings

| PROJECTION | | | | |
|---|---|---|---|---|
| DISTANCE | 193.295 | 121.451 | 468.698 | ∞ |
| DD[10] | 0.7737 | 1.1055 | 0.4276 | 0.2351 |
| DD[12] | 5.2162 | 4.8844 | 5.5622 | 5.7548 |

TABLE 7
Example 2: Specifications (d line)

| | |
|---|---|
| f′ | −1.00 |
| Bf′ | 7.44 |
| FNo. | 1.90 |
| 2ω[°] | 138.0 |

TABLE 8
Example 2: Aspherical coefficients

| SURFACE | | | |
|---|---|---|---|
| NUMBER | 1 | 2 | 21 |
| KA | −1.357388515823E+00 | −1.628705953313E+02 | −4.872660163080E−01 |
| A3 | 1.927223012565E−02 | 3.029280339983E−02 | −4.313575825854E−03 |
| A4 | 3.032368752960E−03 | −2.929320826337E−02 | 1.183477893311E−02 |
| A5 | −1.506190100574E−03 | 3.613072695399E−02 | −6.204842748578E−03 |
| A6 | 9.506883602698E−05 | −2.912223249063E−02 | −4.219268119035E−04 |
| A7 | 2.618753686429E−05 | 1.613112510106E−02 | 2.504562678536E−03 |
| A8 | −3.274595508840E−06 | −6.390039784950E−03 | −9.814946777821E−04 |
| A9 | −2.708318424928E−07 | 1.839206630851E−03 | −3.295964197407E−04 |
| A10 | 5.399476858819E−08 | −3.875341524841E−04 | 3.112587726762E−04 |
| A11 | 1.243165325042E−09 | 5.982210646736E−05 | −1.797276271584E−05 |
| A12 | −4.868622112842E−10 | −6.703214580094E−06 | −4.163302763662E−05 |
| A13 | −3.450374509225E−12 | 5.314457382805E−07 | 9.569956896154E−06 |
| A14 | 2.907940846136E−12 | −2.818732297750E−08 | 2.508650748425E−06 |
| A15 | 2.728310764023E−14 | 8.821667497129E−10 | −1.047793586811E−06 |
| A16 | −1.363243197962E−14 | −1.152486466342E−11 | −3.185471439407E−08 |
| A17 | −9.061680430869E−17 | 4.504417927048E−14 | 5.005748741167E−08 |
| A18 | 4.141531333035E−17 | −7.137718299741E−15 | −3.088940997418E−09 |
| A19 | −2.037231248508E−19 | −1.135101977250E−16 | −9.105469700661E−10 |
| A20 | −3.888230406881E−20 | 1.734292816851E−17 | 1.013077405010E−10 |

| SURFACE | |
|---|---|
| NUMBER | 22 |
| KA | 2.890408453906E−01 |
| A3 | −3.811459499198E−03 |
| A4 | 1.167539328340E−02 |
| A5 | −3.596675902214E−03 |
| A6 | −1.997788696869E−04 |
| A7 | 8.418635798564E−04 |
| A8 | −2.474019158694E−04 |
| A9 | −1.041215110012E−04 |
| A10 | 7.019370236742E−05 |
| A11 | −5.487063314035E−07 |
| A12 | −9.069695280540E−06 |
| A13 | 1.760467224084E−06 |
| A14 | 5.294245003396E−07 |
| A15 | −1.944781073089E−07 |
| A16 | −7.598939014681E−09 |
| A17 | 8.692281104953E−09 |
| A18 | −4.542863465574E−10 |
| A19 | −1.434299223039E−10 |
| A20 | 1.407504975244E−11 |

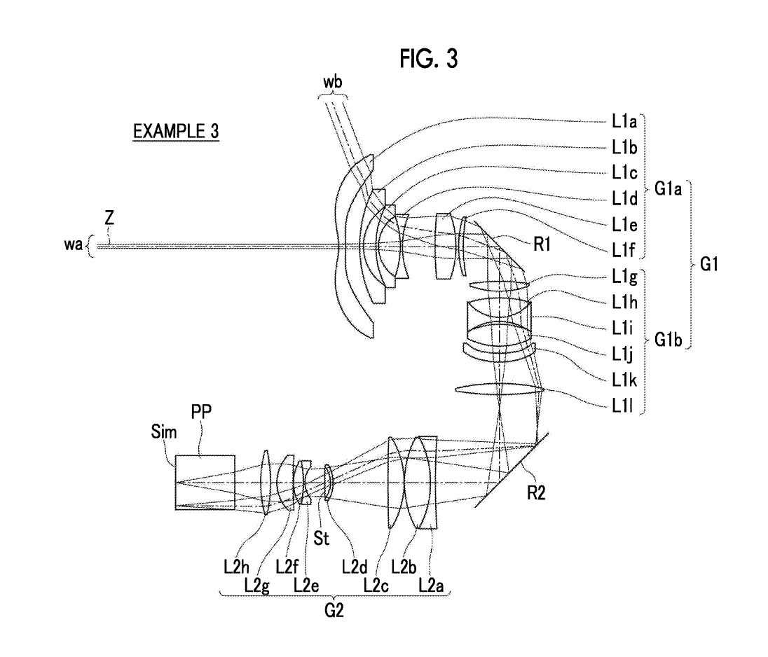

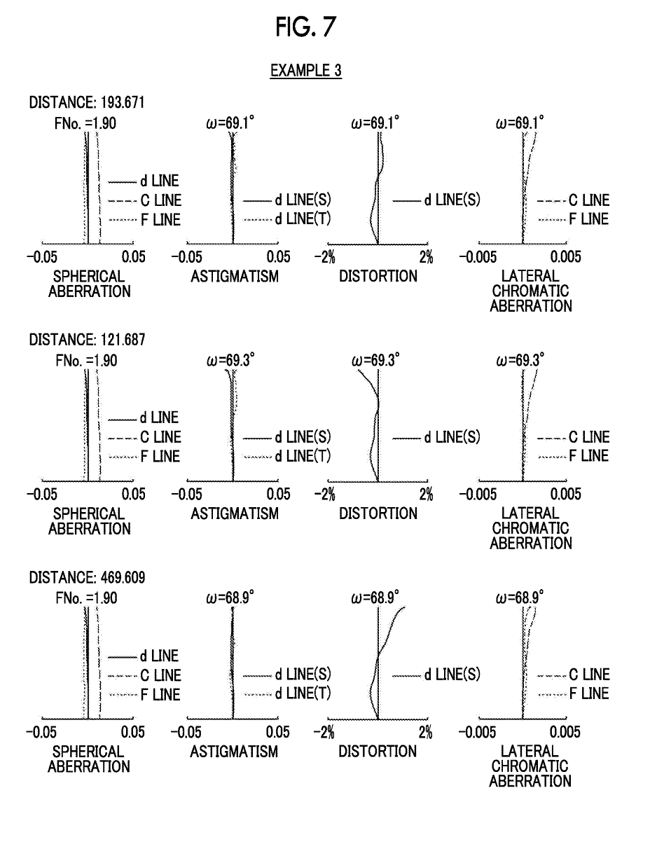

Next, an imaging optical system of Example 3 will be described. FIG. 3 shows a cross-sectional view illustrating a configuration of the imaging optical system of Example 3. The imaging optical system of Example 3 has the same lens number configuration as that in Example 1. In addition, Table 9 shows lens data of the imaging optical system of Example 3, Table 10 shows data relating to surface spacing having a change in spacing during focusing, Table 11 shows data (projection distance of 193.671) relating to specifications, Table 12 shows data relating to aspherical coefficients, and FIG. 7 shows a diagram of aberrations.

TABLE 9
Example 3: Lens data (n and ν are based on the d line)

| SURFACE | RADIUS OF | SURFACE | | |
|---|---|---|---|---|
| NUMBER | CURVATURE | SPACING | n | ν |
| *1 | −5.2679 | 0.7886 | 1.53158 | 55.08 |
| *2 | −14.4837 | 1.6094 | | |
| 3 | 14.4269 | 0.4283 | 1.80400 | 46.58 |
| 4 | 5.3246 | 1.4216 | | |
| 5 | 9.9512 | 0.3085 | 1.77250 | 49.60 |
| 6 | 4.0739 | 2.5062 | | |
| 7 | −10.2914 | 0.2399 | 1.65160 | 58.55 |
| 8 | 9.3608 | 3.7475 | | |
| 9 | 37.0181 | 2.3995 | 1.80400 | 46.58 |
| 10 | −11.0039 | DD[10] | | |
| 11 | 11.0652 | 0.5429 | 1.84666 | 23.78 |
| 12 | 18.7534 | DD[12] | | |
| 13 | 21.8698 | 1.1159 | 1.49700 | 81.61 |
| 14 | −9.9062 | 0.7627 | | |
| 15 | 12.5838 | 2.2148 | 1.69680 | 55.53 |
| 16 | −4.6116 | 0.4839 | 1.80518 | 25.46 |
| 17 | 6.0895 | 0.3177 | | |
| 18 | 8.6388 | 2.5000 | 1.43700 | 95.10 |
| 19 | −7.9833 | 0.7952 | | |
| *20 | −9.6064 | 1.0218 | 1.49100 | 57.58 |
| *21 | −6.4360 | 2.4281 | | |
| 22 | 22.5414 | 1.2808 | 1.84666 | 23.78 |
| 23 | −30.7133 | 17.3990 | | |
| 24 | −71.4789 | 0.5486 | 1.80518 | 25.46 |
| 25 | 10.9590 | 3.0029 | 1.54814 | 45.78 |
| 26 | −10.9703 | 0.0343 | | |
| 27 | 9.9129 | 1.8354 | 1.77250 | 49.60 |
| 28 | −198.7757 | 6.3127 | | |
| 29 | 3.9214 | 0.3132 | 1.59270 | 35.31 |
| 30 | 2.9492 | 0.6395 | | |
| 31 (DIAPHRAGM) | ∞ | 2.2905 | | |
| 32 | −2.8164 | 0.1712 | 1.80518 | 25.46 |
| 33 | 12.1319 | 1.1510 | 1.59282 | 68.62 |
| 34 | −4.6750 | 0.0341 | | |
| 35 | −55.9787 | 1.8633 | 1.49700 | 81.61 |
| 36 | −4.4699 | 0.7306 | | |
| 37 | 17.3160 | 1.1278 | 1.80809 | 22.76 |
| 38 | −13.9766 | 2.9848 | | |
| 39 | ∞ | 6.7879 | 1.51633 | 64.14 |
| 40 | ∞ | | | |

First optical path bending means: position of 4.0000 on magnified side from surface number 13

Second optical path bending means: position of 7.3597 on magnified side from surface number 24

TABLE 10
Example 3: Surface spacings

| PROJECTION | | | | |
|---|---|---|---|---|
| DISTANCE | 193.671 | 121.687 | 469.609 | ∞ |
| DD[10] | 0.3071 | 0.4716 | 0.1391 | 0.0247 |
| DD[12] | 8.1439 | 7.9794 | 8.3119 | 8.4263 |

TABLE 11
Example 3: Specifications (d line)

| | |
|---|---|
| f′ | −1.00 |
| Bf′ | 7.46 |
| FNo. | 1.90 |
| 2ω[°] | 138.2 |

TABLE 12
Example 3: Aspherical coefficients

| SURFACE | | | |
|---|---|---|---|
| NUMBER | 1 | 2 | 20 |
| KA | −1.012705640654E+00 | −1.689574187807E+01 | 1.000000000000E+00 |
| A3 | 1.313590672786E−02 | 2.625714192873E−02 | 0.000000000000E+00 |
| A4 | 3.458547259924E−03 | −2.918484051266E−02 | 9.537933590180E−03 |
| A5 | −1.169940041077E−03 | 3.522343197266E−02 | −4.365562964921E−03 |
| A6 | 7.995291899452E−05 | −2.811366556401E−02 | −1.287307806987E−03 |
| A7 | 1.329980564441E−05 | 1.554819820242E−02 | 9.665869678069E−04 |
| A8 | −2.528111542635E−06 | −6.125563888498E−03 | 5.179981299709E−05 |
| A9 | 1.577910217721E−08 | 1.750330429076E−03 | −1.268083459315E−04 |
| A10 | 3.246425142892E−08 | −3.666602131150E−04 | 2.254629098072E−06 |
| A11 | −2.591118868451E−09 | 5.635341131715E−05 | 1.032307039569E−05 |
| A12 | −1.267895828965E−10 | −6.282206550636E−06 | −3.685019140456E−07 |
| A13 | 2.533086230711E−11 | 4.940977488554E−07 | −5.269014256841E−07 |
| A14 | −4.773445370840E−13 | −2.597779016162E−08 | 1.561792860958E−08 |
| A15 | −7.638974957206E−14 | 8.188069220170E−10 | 1.585353323634E−08 |
| A16 | 3.421892629020E−15 | −1.169316115120E−11 | −1.606044033084E−10 |
| A17 | | | −2.163240404893E−10 |

| SURFACE | |
|---|---|
| NUMBER | 21 |
| KA | 1.000000000000E+00 |
| A3 | 0.000000000000E+00 |
| A4 | 1.316545003836E−02 |
| A5 | −4.314758970233E−03 |
| A6 | −8.622339325173E−04 |
| A7 | 5.831904153225E−04 |
| A8 | 3.852474426708E−05 |
| A9 | −5.290146200922E−05 |
| A10 | −5.448014657821E−06 |
| A11 | 4.252855788801E−06 |
| A12 | 5.151727389511E−07 |
| A13 | −2.575206369834E−07 |
| A14 | −2.064528339338E−08 |
| A15 | 8.899463097362E−09 |
| A16 | 3.025861351437E−10 |
| A17 | −1.257240698682E−10 |

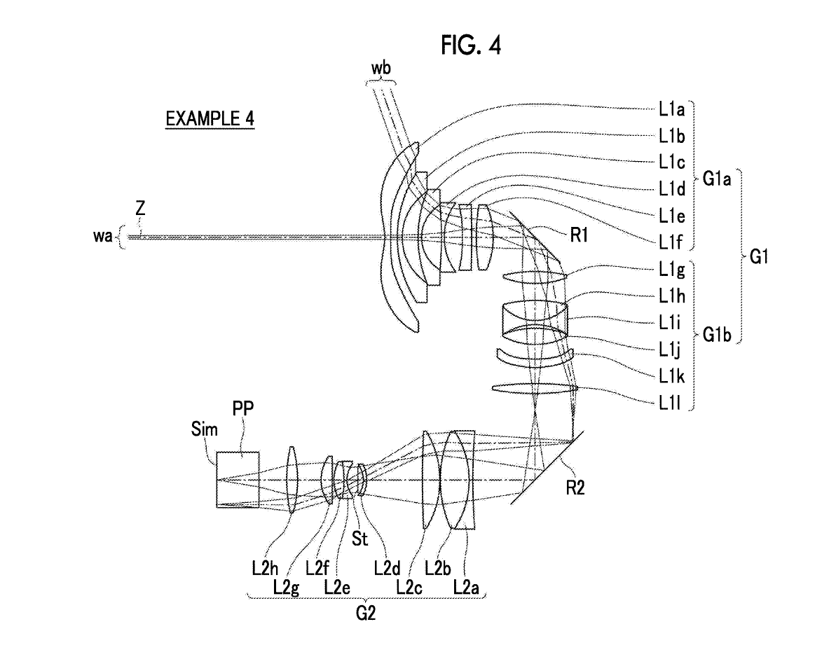

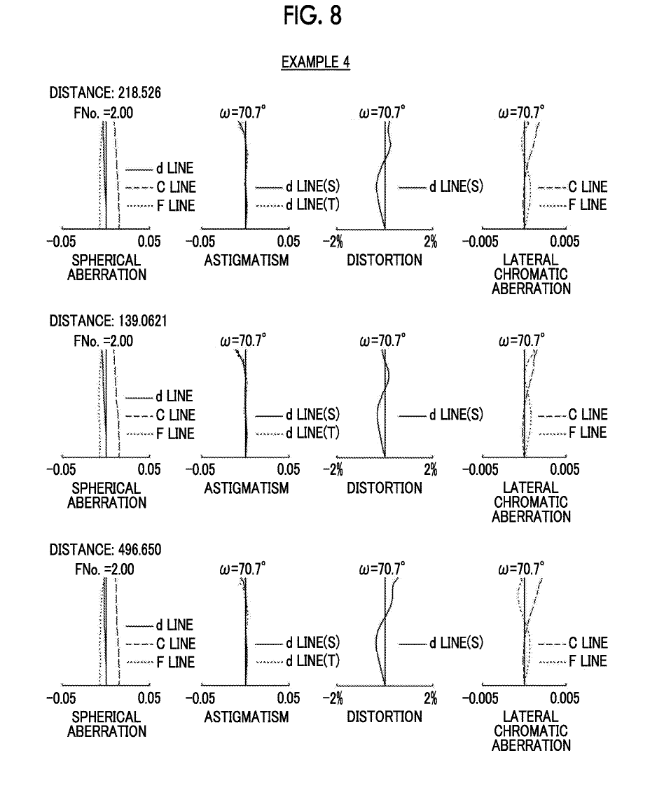

Next, an imaging optical system of Example 4 will be described. FIG. 4 shows a cross-sectional view illustrating a configuration of the imaging optical system of Example 4. The imaging optical system of Example 4 has the same lens number configuration as that in Example 4. In addition, Table 13 shows lens data of the imaging optical system of Example 4, Table 14 shows data relating to surface spacings having a change in spacing during focusing, Table 15 shows data (projection distance of 218.526) relating to specifications, Table 16 shows data relating to aspherical coefficients, and FIG. 8 shows a diagram of aberrations.

TABLE 13
Example 4: Lens data (n and ν are based on the d line)

| SURFACE | RADIUS OF | SURFACE | | |
|---|---|---|---|---|
| NUMBER | CURVATURE | SPACING | n | ν |
| *1 | −5.2611 | 0.7159 | 1.49100 | 57.58 |
| *2 | −23.2691 | 0.7687 | | |
| 3 | 13.8526 | 0.5759 | 1.80400 | 46.58 |
| 4 | 6.3768 | 1.8739 | | |
| 5 | 14.1436 | 0.4171 | 1.83400 | 37.16 |
| 6 | 4.4561 | 2.3492 | | |
| 7 | −40.3818 | 0.3177 | 1.67790 | 55.34 |
| 8 | 6.7298 | DD[8] | | |
| *9 | −53.7443 | 1.0874 | 1.49100 | 57.58 |
| *10 | 165.9761 | DD[10] | | |
| 11 | 24.9817 | 1.9866 | 1.72825 | 28.46 |
| 12 | −9.4218 | 8.9432 | | |
| 13 | 16.0529 | 1.4018 | 1.59282 | 68.62 |
| 14 | −10.8960 | 1.9895 | | |
| 15 | 14.7193 | 2.3635 | 1.67790 | 55.34 |
| 16 | −5.1814 | 0.4769 | 1.80518 | 25.42 |
| 17 | 6.7146 | 0.4155 | | |
| 18 | 10.2639 | 1.9082 | 1.49700 | 81.61 |
| 19 | −8.1363 | 1.7222 | | |
| *20 | −10.8826 | 0.9865 | 1.49100 | 57.58 |
| *21 | −7.3100 | 1.8762 | | |
| 22 | 37.0896 | 1.1785 | 1.84666 | 23.78 |
| 23 | −26.6303 | 17.4730 | | |
| 24 | −69.8886 | 0.4172 | 1.80518 | 25.46 |
| 25 | 10.3042 | 3.4185 | 1.65412 | 39.68 |
| 26 | −13.7004 | 0.0399 | | |
| 27 | 10.8976 | 2.0532 | 1.80400 | 46.58 |
| 28 | −128.0519 | 6.6040 | | |
| 29 | 4.0970 | 0.3764 | 1.59551 | 39.24 |
| 30 | 2.9427 | 0.6475 | | |
| 31 (DIAPHRAGM) | ∞ | 1.2913 | | |
| 32 | −2.9434 | 0.3508 | 1.80518 | 25.46 |
| 33 | 11.3463 | 1.1823 | 1.59282 | 68.62 |
| 34 | −4.6691 | 0.1888 | | |
| 35 | 576.6335 | 1.3327 | 1.49700 | 81.61 |
| 36 | −4.6531 | 2.7712 | | |
| 37 | 14.2916 | 1.2849 | 1.80809 | 22.76 |
| 38 | −17.7908 | 3.2827 | | |
| 39 | ∞ | 4.9665 | 1.51633 | 64.14 |
| 40 | ∞ | | | |

First optical path bending means: position of 4.0000 on magnified side from surface number 13

Second optical path bending means: position of 7.3597 on magnified side from surface number 24

TABLE 14
Example 4: Surface spacings

| PROJECTION | | | | |
|---|---|---|---|---|
| DISTANCE | 218.526 | 139.062 | 496.650 | ∞ |
| DD[8] | 2.1515 | 2.1004 | 2.2023 | 2.2360 |
| DD[10] | 0.5617 | 0.6128 | 0.5109 | 0.4772 |

TABLE 15
Example 4: Specifications (d line)

| | |
|---|---|
| f′ | −1.00 |
| Bf′ | 6.56 |
| FNo. | 2.00 |
| 2ω[°] | 141.4 |

TABLE 16
Example 4: Aspherical coefficients

| SURFACE | | | |
|---|---|---|---|
| NUMBER | 1 | 2 | 9 |
| KA | −1.184822379989E+00 | −9.305091755351E+00 | 1.000000000000E+00 |
| A3 | 1.353926642623E−02 | 2.331979447198E−02 | 0.000000000000E+00 |
| A4 | 2.707370023394E−03 | −2.218985135714E−02 | −5.581491907410E−03 |
| A5 | −1.038047151568E−03 | 2.394248809711E−02 | 1.512855814874E−03 |
| A6 | 7.194239679813E−05 | −1.742432881295E−02 | 3.856836520332E−04 |
| A7 | 1.241019733918E−05 | 8.779831191611E−03 | −2.986384618176E−04 |
| A8 | −2.039449304051E−06 | −3.148133571114E−03 | 1.508994218778E−05 |
| A9 | −3.681062833536E−08 | 8.185434134924E−04 | 2.416079204512E−05 |
| A10 | 2.514643919693E−08 | −1.560531061097E−04 | −3.591373691427E−06 |
| A11 | −1.050815973077E−09 | 2.183069046758E−06 | −7.153566056398E−07 |
| A12 | −1.216488499144E−10 | −2.215039367107E−06 | 1.395382953556E−07 |
| A13 | 1.082205811148E−11 | 1.585481861804E−07 | 0.000000000000E+00 |
| A14 | 4.468710291553E−14 | −7.586168113523E−09 | 0.000000000000E+00 |
| A15 | −3.051813388213E−14 | 2.176411525459E−10 | 0.000000000000E+00 |
| A16 | 8.806800800421E−16 | −2.829959985566E−12 | 0.000000000000E+00 |
| A17 | | | 0.000000000000E+00 |
| SURFACE | | | |
| NUMBER | 10 | 20 | 21 |
| KA | 1.000000000000E+00 | 1.000000000000E+00 | 1.000000000000E+00 |
| A3 | 0.000000000000E+00 | 0.000000000000E+00 | 0.000000000000E+00 |
| A4 | −3.037217813671E−03 | 7.167220762451E−03 | 1.011569072187E−02 |
| A5 | 9.188176967567E−04 | −3.375610460888E−03 | −3.737609978392E−03 |
| A6 | 2.557113678440E−04 | −6.432858936485E−04 | −1.352207282381E−04 |
| A7 | −1.871304047322E−04 | 6.685934706683E−04 | 4.056913937342E−04 |
| A8 | 9.007609190640E−06 | −1.441841120614E−05 | −5.308926499444E−05 |
| A9 | 1.524769208219E−05 | −7.466465354350E−05 | −2.175482638087E−05 |
| A10 | −2.318467197874E−06 | 6.836998479944E−06 | 4.147662164765E−06 |
| A11 | −4.336238649110E−07 | 5.040451669491E−06 | 6.054858367578E−07 |
| A12 | 8.588271661949E−08 | −6.207252742956E−07 | −1.435524287456E−07 |
| A13 | 0.000000000000E+00 | −2.092327772822E−07 | −7.104840043680E−09 |
| A14 | 0.000000000000E+00 | 2.568304693879E−08 | 2.703143598466E−09 |
| A15 | 0.000000000000E+00 | 4.956740181054E−09 | −1.010400387283E−11 |
| A16 | 0.000000000000E+00 | −3.916452762377E−10 | −2.281502662944E−11 |
| A17 | 0.000000000000E+00 | −5.090809233527E−11 | 6.281902700895E−13 |

Table 17 shows values corresponding to Conditional Expressions (1) to (5) of the imaging optical systems of Examples 1 to 4. Meanwhile, the d line is used as a reference wavelength in all the examples, and values shown in the following Table 17 are equivalent to those at this reference wavelength.

TABLE 17

| EXPRESSION | CONDITIONAL | EXAM- | EXAM- | EXAM- | EXAM- |
|---|---|---|---|---|---|
| NUMBER | EXPRESSION | PLE 1 | PLE 2 | PLE 3 | PLE 4 |
| (1) | \|tan (θ)\| | 0.059 | 0.022 | 0.054 | 0.026 |
| (2) | \|Im φ/exP\| + | 0.132 | 0.087 | 0.101 | 0.099 |
| | \|tan (θ)\| | | | | |
| (3) | D12/\|f\| | 17.38 | 15.58 | 17.26 | 17.48 |
| (4) | f1/\|f\| | 1.83 | 1.49 | 1.73 | 1.65 |
| (5) | Bf/\|f\| | 7.68 | 7.37 | 7.40 | 6.56 |

From the above-mentioned data, it can be understood that the imaging optical systems of Examples 1 to 4 all satisfy Conditional Expressions (1) to (5), and are imaging optical systems, having satisfactory optical characteristics, which are capable of readily switching horizontal or vertical projection without inclining a projection-type display apparatus by 90 degrees in a case of being mounted in the projection-type display apparatus.

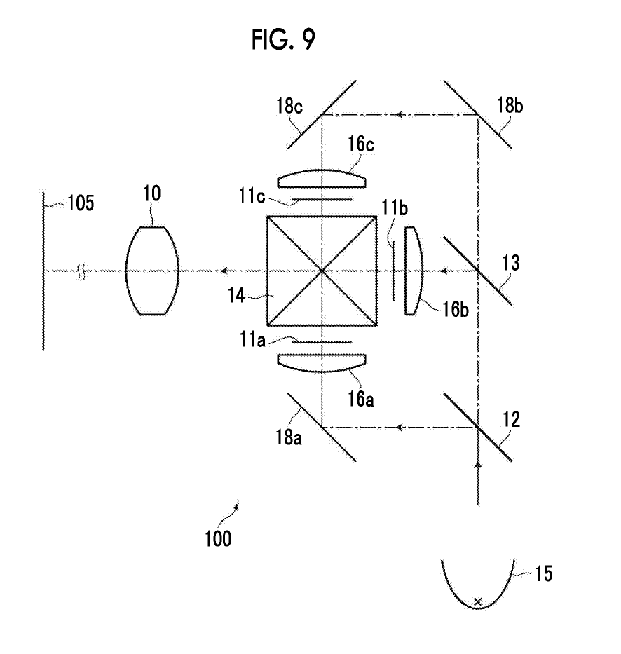

Next, a projection-type display apparatus according to an embodiment of the present invention will be described. FIG. 9 is a schematic configuration diagram of a projection-type display apparatus according to the embodiment of the present invention. A projection-type display apparatus 100 shown in FIG. 9 includes an imaging optical system 10 according to an embodiment of the present invention, a light source 15, transmission-type display devices 11a to 11c as light valves corresponding to respective beams of colored light, dichroic mirrors 12 and 13 for color decomposition, a cross dichroic prism 14 for color synthesis, capacitor lenses 16a to 16c, and total reflection mirrors 18a to 18c for deflecting an optical path. Meanwhile, in FIG. 9, the imaging optical system 10 is schematically shown. In addition, an integrator is disposed between the light source 15 and the dichroic mirror 12, but is not shown in FIG. 9.

White light from the light source 15 is decomposed into three colored light fluxes (G light, B light, and R light) by the dichroic mirrors 12 and 13. The decomposed light fluxes are then incident on the transmission-type display devices 11a to 11c corresponding to the respective colored light fluxes through the capacitor lenses 16a to 16c, respectively, and are optically modulated. The modulated light fluxes are color-synthesized by the cross dichroic prism 14, and then are incident on the imaging optical system 10. The imaging optical system 10 projects an optical image of light optically modulated by the transmission-type display devices 11a to 11c onto a screen 105.

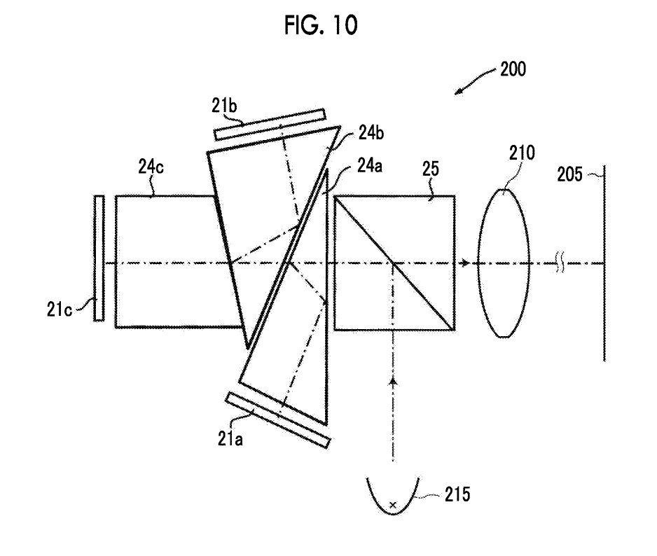

FIG. 10 is a schematic configuration diagram of a projection-type display apparatus according to another embodiment of the present invention. A projection-type display apparatus 200 shown in FIG. 10 includes an imaging optical system 210 according to the embodiment of the present invention, a light source 215, DMDs 21a to 21c as light valves corresponding to respective beams of colored light, total internal reflection (TIR) prisms 24a to 24c for color decomposition and color synthesis, and a polarization separation prism 25 that separates illumination light and projected light. Meanwhile, in FIG. 10, the imaging optical system 210 is schematically shown. In addition, an integrator is disposed between the light source 215 and the polarization separation prism 25, but is not shown in FIG. 10.

White light from the light source 215 is reflected from a reflecting surface inside the polarization separation prism 25, and then is decomposed into three colored light fluxes (G light, B light, and R light) by the TIR prisms 24a to 24c. The respective colored light fluxes after the decomposition are incident on the DMDs 21a to 21c corresponding thereto and are optically modulated. The modulated light fluxes travel through the TIR prisms 24a to 24c again in an opposite direction and are color-synthesized. The synthesized light passes through the polarization separation prism 25 and is incident on the imaging optical system 210. The imaging optical system 210 projects an optical image of light optically modulated by the DMDs 21a to 21c onto a screen 205.

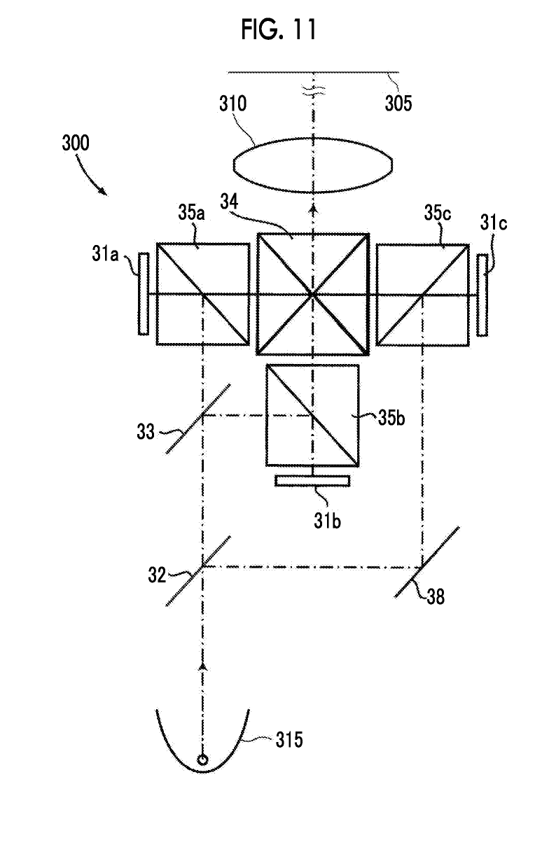

FIG. 11 is a schematic configuration diagram of a projection-type display apparatus according to still another embodiment of the present invention. A projection-type display apparatus 300 shown in FIG. 11 includes an imaging optical system 310 according to the embodiment of the present invention, a light source 315, reflection-type display devices 31a to 31c as light valves corresponding to respective beams of colored light, dichroic mirrors 32 and 33 for color separation, a cross dichroic prism 34 for color synthesis, a total reflection mirror 38 for optical path deflection, and polarization separation prisms 35a to 35c. Meanwhile, in FIG. 11, the imaging optical system 310 is schematically shown. In addition, an integrator is disposed between the light source 315 and the dichroic mirror 32, but is not shown in FIG. 11.

White light from light source 315 is decomposed into three colored light fluxes (G light, B light, and R light) by the dichroic mirrors 32 and 33. The respective colored light fluxes after the decomposition are incident on the reflection-type display devices 31a to 31c corresponding to the respective colored light fluxes through the polarization separation prisms 35a to 35c, respectively, and are optically modulated. The modulated light fluxes are color-synthesized by the cross dichroic prism 34, and then are incident on the imaging optical system 310. The imaging optical system 310 projects an optical image of light optically modulated by the reflection-type display devices 31a to 31c onto a screen 305.

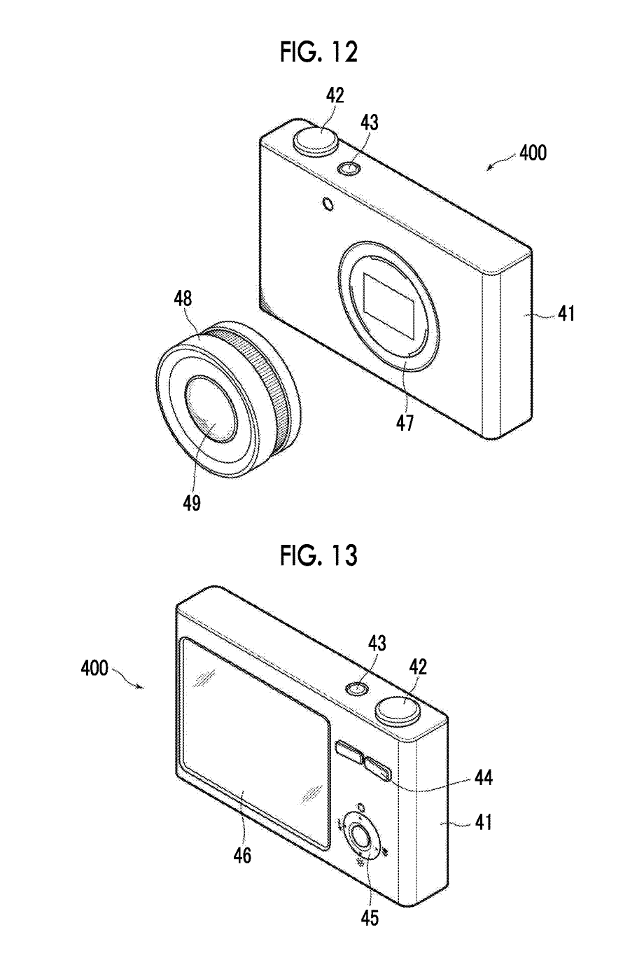

FIGS. 12 and 13 are appearance diagrams of a camera 400 which is an imaging apparatus of an embodiment of the present invention. FIG. 12 shows a perspective view when the camera 400 is seen from the front side, and FIG. 13 is a perspective view when the camera 400 seen from the rear surface side. The camera 400 is a single-lens digital camera, having no reflex finder, which has an interchangeable lens 48 detachably mounted therein. The interchangeable lens 48 has an imaging optical system 49 which is an optical system according to the embodiment of the present invention housed within a lens barrel.

This camera 400 includes a camera body 41, and is provided with a shutter button 42 and a power button 43 on the upper surface of the camera body 41. In addition, operating portions 44 and 45 and a display portion 46 are provided on the rear surface of the camera body 41. The display portion 46 is used for displaying a captured image or an image within an angle of view before image capture.

An imaging aperture on which light from an imaging target is incident is provided on the front central portion of the camera body 41, a mount 47 is provided at a position corresponding to the imaging aperture, and the interchangeable lens 48 is mounted onto the camera body 41 through the mount 47.

The camera body 41 is provided therein with an imaging device (not shown) such as a charge coupled device (CCD) that outputs an imaging signal according to a subject image formed by the interchangeable lens 48, a signal processing circuit that processes the imaging signal which is output from the imaging device to generate an image, a recording medium for recording the generated image, and the like. In this camera 400, a still image or a moving image can be captured by pressing the shutter button 42, and image data obtained by this image capture is recorded in the recording medium.

Hereinbefore, the present invention has been described through embodiments and examples, but the imaging optical systems of the present invention are not limited to those of the above examples, and can be variously modified. For example, it is possible to appropriately change the radius of curvature, the surface spacing, the refractive index, and the Abbe number of each lens.

In addition, the projection-type display apparatuses of the present invention are also not limited to the above configurations. For example, the light valves which are used and the optical members which are used for light flux separation or light flux synthesis are not limited to the above configurations, and can be modified in various forms.

In addition, the imaging apparatus of the present invention is also not limited to the above configuration, and can also be applied to, for example, a single-lens reflex camera, a film camera, a video camera, and the like.

### EXPLANATION OF REFERENCES

10, 210, 310: imaging optical system
11a to 11c: transmission-type display device
12, 13, 32, 33: dichroic mirror
14, 34: cross dichroic prism
15, 215, 315: light source
16a to 16c: capacitor lens
18a to 18c, 38: total reflection mirror
21a to 21c: DMD
24a to 24c: TIR prism
25, 35a to 35c: polarization separation prism
31a to 31c: reflection-type display device
41: camera body
42: shutter button
43: power button
44, 45: operating portion
46: display portion
47: mount
48: interchangeable lens
49: imaging optical system
100, 200, 300: projection-type display apparatus
105, 205, 305: screen
400: camera
G1: first optical system
G2: second optical system
L1a to L2h: lens
PP: optical member
R1: first optical path bending means
R2: second optical path bending means
Sim: image display surface
St: aperture diaphragm
wa: on-axis light flux
wb: light flux of maximum angle of view
Z: optical axis

What is claimed is:

1. An imaging optical system capable of projecting an image, displayed on an image display device disposed on a reduced-side conjugate plane, as a magnified image on a magnified-side conjugate plane, the system comprising, in order from a magnified side:
a first optical system consisting of a first lens group, first optical path bending means for bending an optical path on a reflecting surface, and a second lens group;
second optical path bending means for bending an optical path on a reflecting surface; and
a second optical system which is constituted by a plurality of lenses,
wherein the second optical system forms the image on the image display device as an intermediate image,
the first optical system forms the intermediate image on the magnified-side conjugate plane,
the first optical path bending means and/or the second optical path bending means is disposed in a direction in which the optical path is bent by 90 degrees,
the first optical system is capable of being rotated using an optical axis of the second lens group as an axis of rotation, and
the following Conditional Expression (1) is satisfied,

|tan(θ)|<0.15 (1)
where θ is a maximum angle among angles which are formed by respective principal rays of light from the second optical system toward the second optical path bending means with respect to the normal line of the reduced-side conjugate plane.

2. The imaging optical system according to claim 1, wherein the following Conditional Expression (2) is satisfied,
0.02<|Imφ/exP|+|tan(θ)|<0.20 (2)
where Imφ is an effective image circle diameter on the reduced side, and
exP is a distance on the optical axis from the reduced-side conjugate plane to a paraxial exit pupil position when the reduced side is set to an exit side.

3. The imaging optical system according to claim 1, wherein the following Conditional Expression (3) is satisfied,
8.0<D12/|f|<30.0 (3)
where D12 is a distance on the optical axis between the first optical system and the second optical system, and
f is a focal length of the whole system.

4. The imaging optical system according to claim 1, wherein the following Conditional Expression (4) is satisfied,
1.2<f1/|f|<2.8 (4)
where f1 is a focal length of the first optical system, and
f is a focal length of the whole system.

5. The imaging optical system according to claim 1, wherein the following Conditional Expression (5) is satisfied,
4.0<Bf/|f| (5)
where Bf is a back focus of the whole system, and
f is a focal length of the whole system.

6. The imaging optical system according to claim 1, wherein the first optical system and the second optical system have a common optical axis.

7. The imaging optical system according to claim 1, wherein the intermediate image has an image plane curvature on the second optical system side in its peripheral portion rather than a center of an optical axis.

8. The imaging optical system according to claim 1, wherein the following Conditional Expression (1-1) is satisfied.

|tan(θ)|<0.10 (1-1)

9. The imaging optical system according to claim 2, wherein the following Conditional Expression (2-1) is satisfied.
0.04<|Imφ/exP|+|tan(θ)|<0.18 (2-1)

10. The imaging optical system according to claim 3, wherein the following Conditional Expression (3-1) is satisfied.
10.0<D12/|f|<25.0 (3-1)

11. The imaging optical system according to claim 4, wherein the following Conditional Expression (4-1) is satisfied.
1.4<f1/|f|<2.2 (4-1)

12. The imaging optical system according to claim 5, wherein the following Conditional Expression (5-1) is satisfied.
5.0<Bf/|f|<20.0 (5-1)

13. A projection-type display apparatus comprising:
a light source;
a light valve on which light from the light source is incident; and
the imaging optical system according to claim 1 as an imaging optical system that projects an optical image of light optically modulated by the light valve onto a screen.

14. An imaging apparatus comprising the imaging optical system according to claim 1.
